(19) United States
(12) Patent Application Publication
(10) Pub. No.: US 2026/0241993 A1
(43) Pub. Date: Aug. 20, 2026

(54) STEERING ANGLE CONTROL APPARATUS AND STEERING ANGLE CONTROL METHOD

(71) Applicant: Honda Motor Co., Ltd., Tokyo (JP)

(72) Inventors: Kazuki Tomioka, Tokyo (JP); Yuta Tsurumoto, Tokyo (JP)

(21) Appl. No.: 19/536,104

(22) Filed: Feb. 10, 2026

(30) Foreign Application Priority Data
Feb. 14, 2025 (JP) 2025-022426

(51) Int. Cl. B62D 15/02

(52) U.S. Cl. CPC B62D 15/024

(57) ABSTRACT

A steering angle control apparatus performs: estimating a vehicle state quantity not acquired by a sensor of the vehicle, based on a vehicle state quantity acquired by the sensor, predicting, up to a predetermined time ahead, a behavior of the vehicle including a deviation of the vehicle with respect to the target route, based on information regarding the target route. The apparatus, in the estimating, uses a first vehicle model modeling a relationship between the vehicle state quantities and the vehicle characteristic information, and predicts the behavior using a prediction model including a second vehicle model modeling a relationship between the vehicle state quantities and the vehicle characteristic information. The state estimation model and the prediction model have different methods of discretization. Information regarding the steering angle as the first vehicle state quantity is input in different formats to the first and the second vehicle models.

### CROSS-REFERENCE TO RELATED APPLICATION

This application is based upon and claims the benefit of priority from Japanese Patent Application No. 2025-022426 filed on Feb. 14, 2025, the content of which is incorporated herein by reference.

### BACKGROUND

### Technical Field

The present invention relates to a steering angle control apparatus and a steering angle control method for controlling a steering angle of a vehicle based on a vehicle model modeling a motion state of a vehicle.

### Related Art

As a method for computing a future turning trajectory of a vehicle, a technique is known in which an actual steering angle speed is obtained from an actual steering angle of the vehicle, and the future turning trajectory of the vehicle is computed based on the actual steering angle, the actual steering angle speed, and a vehicle speed (see JP 2000-171560 A).

The technique described in JP 2000-171560 A discloses that a steering angle speed is obtained from a steering angle of a vehicle and that a future trajectory of the vehicle is obtained based on the steering angle, the steering angle speed, and a vehicle speed. However, details are not disclosed, and for example, steering control in the case of traveling along a target path has not been clarified, and there is room for improvement.

Performing follow driving along the target path leads to suppression of a decrease in traffic smoothness while improving traffic safety. Accordingly, it is possible to contribute to development of a sustainable transportation system.

### SUMMARY

An aspect of the present invention is a steering angle control apparatus configured to control a steering angle of a vehicle such that the vehicle travels following a target route. The steering angle control apparatus includes: a microprocessor; and a memory connected to the microprocessor. The microprocessor is configured to perform: estimating a second vehicle state quantity not acquired by a sensor of the vehicle, based on a first vehicle state quantity acquired by the sensor, among vehicle state quantities indicating a motion state of the vehicle; predicting, up to a predetermined time ahead, a behavior of the vehicle including deviations in a position and a direction of the vehicle with respect to the target route, based on the first vehicle state quantity, the second vehicle state quantity, and information indicating the target route; and optimizing a target steering angle by using a result of the predicting. The microprocessor is configured to perform: the estimating including estimating using a first vehicle model modeling a relationship between the first vehicle state quantity and the second vehicle state quantity, and vehicle characteristic information regarding a motion characteristic of the vehicle; the predicting including predicting, up to the predetermined time ahead, the behavior using a prediction model including a second vehicle model modeling a relationship between the first vehicle state quantity and the second vehicle state quantity, and the vehicle characteristic information; the state estimation model and the prediction model have different methods of discretization; and information regarding the steering angle as the first vehicle state quantity is input in different formats to the first vehicle model and the second vehicle model.

Another aspect of the present invention is a steering angle control method for controlling a steering angle of a vehicle such that the vehicle travels following a target route, the steering angle control apparatus including: estimating a second vehicle state quantity not acquired by a sensor of the vehicle, based on a first vehicle state quantity acquired by the sensor, among vehicle state quantities indicating a motion state of the vehicle; predicting, up to a predetermined time ahead, a behavior of the vehicle including deviations in a position and a direction of the vehicle with respect to the target route, based on the first vehicle state quantity, the second vehicle state quantity, and information indicating the target route; and optimizing a target steering angle by using a result of the predicting. The estimating includes estimating using a first vehicle model modeling a relationship between the first vehicle state quantity and the second vehicle state quantity, and vehicle characteristic information regarding a motion characteristic of the vehicle, the predicting includes predicting, up to the predetermined time ahead, the behavior using a prediction model including a second vehicle model modeling a relationship between the first vehicle state quantity and the second vehicle state quantity, and the vehicle characteristic information, the state estimation model and the prediction model have different methods of discretization, and information regarding the steering angle as the first vehicle state quantity is input in different formats to the first vehicle model and the second vehicle model.

### BRIEF DESCRIPTION OF THE DRAWINGS

The objects, features, and advantages of the present invention will become clearer from the following description of embodiments in relation to the attached drawings, in which:

FIG. 1 is a block diagram illustrating a configuration of a vehicle control system including a steering angle control apparatus according to an embodiment of the present invention;

FIG. 2 is a block diagram illustrating a main configuration of a steering angle control apparatus;

FIG. 3A is a block diagram for explaining a flow of steering angle control;

FIG. 3B is a block diagram illustrating details of the steering angle control unit in FIG. 3A;

FIG. 4A is a diagram illustrating a predicted route that follows a target route;

FIG. 4B is a schematic diagram illustrating a relationship between a two-wheel model and the target route according to the embodiment; and

FIG. 5 is a flowchart illustrating an example of computation processing executed by the processing unit in FIG. 2 according to a program.

### DETAILED DESCRIPTION

Hereinafter, embodiments of the invention will be described below with reference to the drawings.

A steering angle control apparatus according to an embodiment of the present invention controls a steering angle of a steering apparatus (for example, a power steering apparatus) of a vehicle as a control target, such that the vehicle follows a target route (which may also be referred to as a target path). The steering angle control apparatus can be applied to, for example, a vehicle having a self-driving capability, that is, a self-driving vehicle.

Note that the steering angle control apparatus according to the embodiment can be applied to both a manual driving vehicle having a driving assistance capability and a self-driving vehicle, but for the sake of convenience of description, a case where the steering angle control apparatus is applied to a self-driving vehicle will be described below as an example.

Furthermore, in the embodiment, a vehicle on which the steering angle control apparatus is mounted may be referred to as a subject vehicle to be distinguished from other vehicles. The subject vehicle may be any of an engine vehicle having an internal combustion engine (engine) as a traveling drive source, an electric vehicle having a traveling motor as a traveling drive source, and a hybrid vehicle having an engine and a traveling motor as a traveling drive source. The subject vehicle is capable of traveling not only in a self-drive mode that does not require a driver's driving operation but also traveling in a manual drive mode that requires a driver's driving operation.

### <Vehicle Configuration>

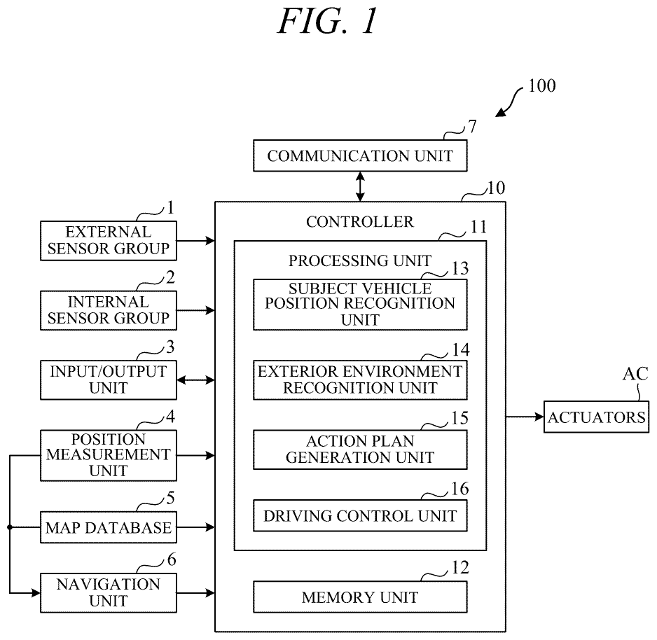

First, a schematic configuration of the subject vehicle related to self-driving will be described. FIG. 1 is a block diagram illustrating a configuration of a vehicle control system 100 of a subject vehicle including the steering angle control apparatus according to the embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC, each of which is communicably connected with the controller 10.

The “external sensor group 1” is a generic term for a plurality of sensors (external sensors) that detect an external situation that is surrounding information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by irradiating electromagnetic waves and detecting reflected waves, and a camera or the like that is installed in the subject vehicle, has an imaging element (image sensor) such as a charge coupled device (CCD) or a complementary metal oxide semiconductor (CMOS) sensor, and captures images of the surrounding (front, rear, and side) of the subject vehicle.

The “internal sensor group 2” is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction (advancing direction) of the subject vehicle and an acceleration (lateral acceleration) in a left-right direction (lane width direction) of the subject vehicle, a revolution sensor that detects the number of revolutions of the traveling drive source, and a yaw rate sensor or the like that detects a rotation angle speed around a vertical axis of the center of gravity of the subject vehicle. The internal sensor group 2 also includes sensors that detect a driver's driving operation such as an operation on an accelerator pedal, an operation on a brake pedal, or an operation on a steering wheel in the manual drive mode.

The “input/output device 3” is a generic term for devices to and from which a command is input by a driver or information is output to the driver. For example, the input/output device 3 includes various switches to which a driver inputs various commands by operating an operation member, a microphone to which the driver inputs commands with voice, a display that provides information to the driver via a display image, a speaker that provides information to the driver with voice, and the like.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information to be used by the navigation unit 6, and includes, for example, a magnetic disk or a semiconductor element. The map information includes road position information, information regarding a road shape (a curvature or the like), and position information regarding intersections and branch points. Note that the map information stored in the map database 5 is different from high-precision map information stored in a memory unit 12 of the controller 10.

For example, the navigation unit 6 is a device that searches for a route on roads to a destination that has been input by a driver and that performs travel guidance along the route. The input of the destination and the travel guidance along the searched route are made via the input/output device 3. The route search is performed based on the current position of the subject vehicle measured by the position measurement unit 4, the input destination position, and the map information stored in the map database 5. It is possible to measure the current position of the subject vehicle using detection values of the external sensor group 1, and the route may be searched for, based on the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for every predetermined management area, for example, a wireless LAN, Wi-Fi (registered trademark), Bluetooth (registered trademark), and the like. The acquired map information is output to the map database 5 and the memory unit 12, and the map information is updated.

The actuator AC is a traveling actuator for controlling traveling of the subject vehicle. In a case where the traveling drive source is an engine, the actuator AC includes a throttle actuator that adjusts an opening degree (a throttle opening degree) of a throttle valve of the engine. In a case where the traveling drive source is a traveling motor, the traveling motor is included in the actuator AC. The actuator AC also includes a braking actuator that actuates a braking device of the subject vehicle and a steering actuator that actuates a steering apparatus.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits, not illustrated, such as an I/O interface.

Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores detailed high-precision map information for self-driving. The high-precision map information includes position information of a road, information on a road shape (such as a curvature), information on gradient of a road, position information of intersections and junctions, types and position information of division lines such as white lines, information on number of lanes (driving lanes), lane width and position information of each lane (information on center position of lanes and boundaries of lane positions), position information of landmarks (such as traffic lights, signs, and buildings) serving as marks on the map, and information on road surface profiles such as road surface irregularities. The high-precision map information stored in the memory unit 12 may include high-precision map information acquired from the outside of the subject vehicle via the communication unit 7, or may include high-precision map information created by the subject vehicle itself using detection values of an external sensor group 1 or detection values of the external sensor group 1 and an internal sensor group 2. The memory unit 12 may store programs for various types of control and information such as threshold values used in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (subject vehicle position) on the map, based on the position information for the subject vehicle that has been obtained by the position measurement unit 4 and the map information in the map database 5. The subject vehicle position may be recognized using the high-precision map information stored in the memory unit 12 and surrounding information of the subject vehicle that has been detected by the external sensor group 1, and thus it becomes possible to recognize the subject vehicle position with high accuracy. The movement information (a moving direction and a moving distance) of the subject vehicle may be calculated based on the detection values of the internal sensor group 2, and the position of the subject vehicle can also be recognized.

Note that when the subject vehicle position can be measured by a sensor installed on a road or outside a road side, the subject vehicle position can also be recognized by communicating with the sensor via the communication unit 7.

The exterior environment recognition unit 14 recognizes an external situation around the subject vehicle, based on a signal from the external sensor group 1 such as a camera, a LiDAR, and a radar. For example, a position, a speed, and an acceleration of a surrounding vehicle (a forward vehicle or a rearward vehicle) traveling near the subject vehicle, a position of a nearby vehicle stopped or parked around the subject vehicle, and positions and states of other objects are recognized, and target information is created.

The other objects include a sign, a traffic light, a road, a building, a guardrail, a utility pole, a signboard, a pedestrian, a bicycle, and the like. Indications such as division lines (such as a white line) and stop lines on a road surface are also included in the other objects (roads). The states of other objects include a color (red, green, yellow) of a traffic light, and the moving speed and orientation of a pedestrian or a bicycle. Some of stationary objects among the other objects constitute a landmark serving as an index of the position on the map, and the exterior environment recognition unit 14 also recognizes the position and type of the landmark.

The action plan generation unit 15 generates a driving path (target path) of the subject vehicle from a current time point to a predetermined time ahead, for example, based on a route searched by the navigation unit 6, the high-precision map information stored in the memory unit 12, the subject vehicle position recognized by the subject vehicle position recognition unit 13, and the external situation recognized by the exterior environment recognition unit 14. When a plurality of paths can be present as candidates of the target path on the route searched by the navigation unit 6, the action plan generation unit 15 selects, from among the plurality of paths, an optimal path that satisfies criteria such as compliance with laws and regulations and efficient and safe driving, and generates the selected path as the target route.

Then, the action plan generation unit 15 generates an action plan corresponding to the generated target route. The action plan generation unit 15 generates various action plans corresponding to drive modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. In generating the target route, the action plan generation unit 15 first determines a drive mode, and then generates the target route, based on the drive mode.

In the self-drive mode, the driving control unit 16 controls each actuator AC such that the subject vehicle drives along the target route generated by the action plan generation unit 15. For example, the driving control unit 16 calculates a requested drive force for obtaining target acceleration for each unit time calculated by the action plan generation unit 15 in consideration of a driving resistance determined according to a road gradient or the like in the self-drive mode. For example, the actuator AC is feedback-controlled such that an actual acceleration detected by the internal sensor group 2 becomes the target acceleration. That is, the driving actuator AC is controlled such that the subject vehicle drives at the target vehicle speed and the target acceleration.

In addition, the driving control unit 16 calculates an optimal steering angle for causing the subject vehicle to follow the target route, based on a vehicle state quantity and the like observed by the internal sensor group 2 and the like in the self-drive mode. Then, a steering angle instruction signal corresponding to the calculated steering angle is output to control the steering actuator AC.

Note that in the manual drive mode, the driving control unit 16 controls each actuator AC in accordance with a drive command (such as a steering operation) from the driver acquired by the internal sensor group 2.

In the lane keep driving, by the way, the steering actuator (hereinafter, also referred to as a steering actuator) is controlled so that the subject vehicle travels while passing through a target position in a lane width direction. However, when a disturbance such as a change in slope of the road surface (a change in gradient in the lane width direction) or a strong crosswind occurs, there is a possibility that the position of the subject vehicle in the lane width direction deviates from the target position, or the orientation of the subject vehicle deviates from the advancing direction.

Therefore, in the embodiment, the following steering angle control apparatus is configured to eliminate the positional deviation of the subject vehicle occurring during traveling and the orientation deviation of the subject vehicle occurring during traveling.

### <Steering Angle Control Apparatus>

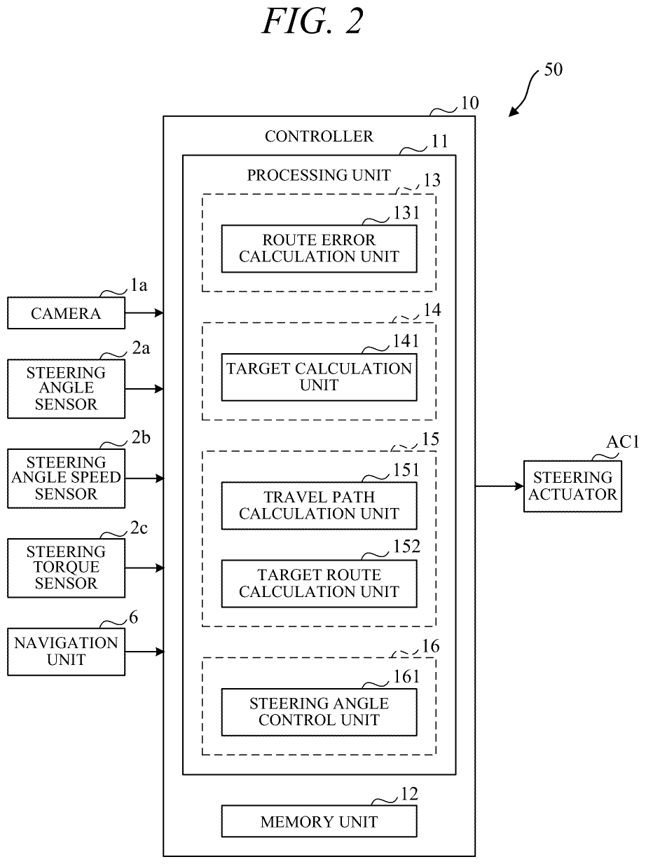

FIG. 2 is a block diagram illustrating a main configuration of a steering angle control apparatus 50 according to the embodiment. As an example, the steering angle control apparatus 50 is configured as a part of the function of the controller 10 in FIG. 1. A camera 1a, a steering angle sensor 2a, a steering angle speed sensor 2b, a steering torque sensor 2c, a navigation unit 6, and a steering actuator AC1 are connected to the controller 10.

The camera 1a is a monocular camera having an imaging element, and constitutes a part of the external sensor group 1 in FIG. 1. The camera 1a may be a stereo camera. The camera 1a is mounted at a predetermined position, for example, in a front part of the subject vehicle, and continuously images a space on a forward side of the subject vehicle to acquire an image (camera image) of a target object. The target object includes a division line or the like that defines a lane on a road. Note that the target object may be detected by a radar, a LiDAR, or the like instead of the camera 1a or together with the camera 1a.

The steering angle sensor 2a detects, for example, a rotation angle (steering angle) of a steering shaft coupled to a steering wheel (not illustrated). The steering angle speed sensor 2b detects a rotation angle speed (also referred to as a steering angle speed) of the steering shaft. The steering torque sensor 2c detects a steering operation by the driver, more specifically, steering torque that acts on the steering wheel. For example, the steering angle detected by the steering angle sensor 2a when the steering wheel is rotated leftward (counterclockwise) from the neutral position is set to a positive value, and the steering angle detected by the steering angle sensor 2a when the steering wheel is rotated rightward (clockwise) from the neutral position is set to a negative value.

The steering angle sensor 2a, the steering angle speed sensor 2b, and the steering torque sensor 2c constitute a part of the internal sensor group 2 of FIG. 1. Note that an Inertial Measurement Unit (IMU) that detects translational motion and rotational motion in three axial directions of the subject vehicle may be provided as one of the internal sensor group 2.

The controller 10 includes a route error calculation unit 131, a target calculation unit 141, a travel path calculation unit 151, a target route calculation unit 152, and a steering angle control unit 161 as functional configurations which the processing unit 11 (FIG. 1) is responsible for. Furthermore, as described above, the controller 10 includes the memory unit 12.

Note that the route error calculation unit 131 may constitute a part of the subject vehicle position recognition unit 13. The target calculation unit 141 may constitute a part of the exterior environment recognition unit 14. The travel path calculation unit 151 and the target route calculation unit 152 may constitute a part of the action plan generation unit 15. The steering angle control unit 161 may constitute a part of the driving control unit 16.

### <Route Error>

The route error calculation unit 131 compares the position and orientation of the subject vehicle recognized by the subject vehicle position recognition unit 13 with a target route set by the target route calculation unit 152 to be described later, and calculates a route lateral position deviation and a route heading angle deviation of the subject vehicle with respect to the target route immediately beside the subject vehicle.

The route error calculation unit 131 first recognizes the position and shape of the division line that defines the lane from the camera image of the camera 1a, and recognizes the lane on based on its recognition result. Next, the route error calculation unit 131 compares the recognized position, angle, and shape of the lane with the target route set by the target route calculation unit 152 to be described later, and calculates, as a route lateral position deviation, a deviation amount between the position of the subject vehicle and the position (lane center) on the target route immediately beside the subject vehicle. In addition, a deviation amount between the orientation of the subject vehicle and the heading angle of the target route immediately beside the subject vehicle is calculated as a route heading angle deviation.

The route error calculation unit 131 may calculate the route lateral position deviation and the route heading angle deviation by using the subject vehicle position and orientation recognized based on the high-precision map information stored in the memory unit 12 and the surrounding information of the subject vehicle detected by the external sensor group 1, or the subject vehicle position and orientation measured by the position measurement unit 4.

### <Target>

The target calculation unit 141 calculates information indicating a target existing around the subject vehicle. The target calculation unit 141 recognizes a target including a moving object such as other vehicle, a bicycle, and a pedestrian, and a stationary object (also referred to as a feature) such as a guardrail or a sign based on signals input from the external sensor group 1 such as the camera 1a, a LiDAR, and a radar, and outputs target information indicating the recognized target.

### <Base Travel Path>

The travel path calculation unit 151 calculates (searches for) a travel path (referred to as a base travel path) based on the current position of the subject vehicle measured by the position measurement unit 4, the position of the destination input from the driver, and the map information stored in the map database 5. The calculation of the base travel path is similar to the search for the route by the navigation unit 6. The travel path calculation unit 151 may acquire, as the base travel path, the route set by the navigation unit 6 from the navigation unit 6.

### <Target Route>

The target route calculation unit 152 sets, on the base travel path, a target position in the lane width direction through which the subject vehicle is to pass, based on the base travel path calculated by the travel path calculation unit 151 and the external situation recognized by the exterior environment recognition unit 14. When the subject vehicle is traveling, for example, in the lane keep driving, the target route calculation unit 152 repeatedly sets the target position along the advancing direction. As a result, a target route (a path obtained by connecting the target positions) is generated along the base travel path.

Note that when the exterior environment recognition unit 14 recognizes an obstacle such as a utility pole or a parked vehicle on a forward side in the advancing direction of the subject vehicle, the target route calculation unit 152 sets the target position using the target information output from the target calculation unit 141, so that a distance between the subject vehicle and the obstacle in the lane width direction is not shorter than a certain distance when the subject vehicle passes on a lateral side of the obstacle. In addition, when a lane change instruction is input from the driver via a direction indicator (not illustrated), the target route calculation unit 152 sets the target position so that the traveling position of the subject vehicle gradually moves to the center of the lane which is a change destination, along the advancing direction.

### <Steering Angle Control>

For example, in the case of lane keep driving, the steering angle control unit 161 controls the steering angle via the steering actuator AC1 such that the subject vehicle travels following the target route. Specifically, the steering angle control unit 161 calculates a steering angle necessary for causing the position of the subject vehicle to follow the target route.

### <Acquisition of Vehicle State Quantity>

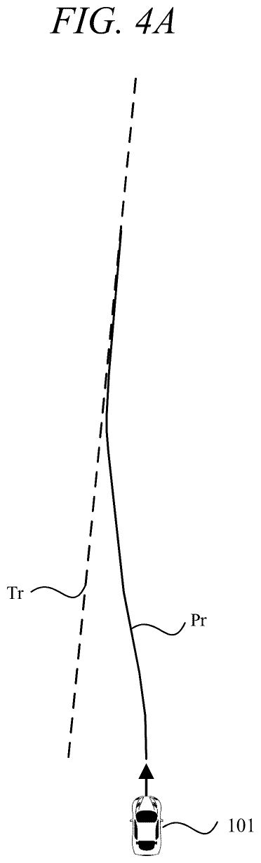

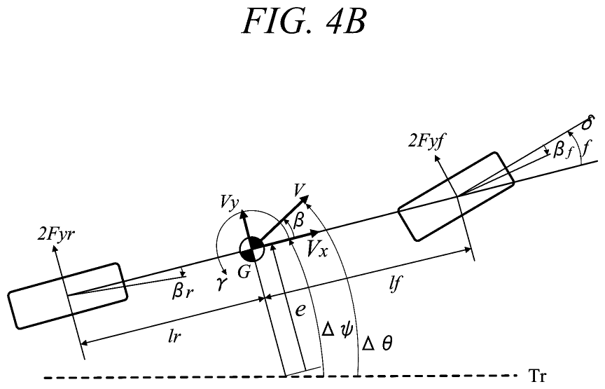

The steering angle control unit 161 first acquires the target route generated by the target route calculation unit 152. In addition, the steering angle control unit 161 acquires a vehicle mass m [kg] of the subject vehicle, a yaw moment of inertia IZ [kgm²], a distance lf [m] between the center of gravity G and a front axle, a distance lr [m] between the center of gravity G and a rear axle, an equivalent cornering power Kf [N/rad] of one front wheel, an equivalent cornering power Kr [N/rad] of one rear wheel, a stability factor A [−], and the like from the memory unit 12 as design information regarding the subject vehicle. These may be referred to as vehicle characteristic information regarding a motion characteristic. In addition, some of them correspond to respective symbols in FIG. 4B described later.

The steering angle control unit 161 further acquires, as vehicle state quantities, a vehicle speed (vehicle body speed) V [m/s] of the subject vehicle, a yaw angle speed (yaw rate) γ [rad/s], a front-wheel steering angle δf [rad], a gravitational acceleration g [m/s²], a steering angle speed of [rad/s], a vehicle body orientation, the above route lateral position deviation e [m], a route heading angle deviation Δψ [rad] of the vehicle body, a yaw angle speed deviation Δγ [rad/s], and the like, from the output value of the sensor constituting the internal sensor group 2 or by calculation using the output value of the sensor.

The above “′” indicates time differentiation. That is, the steering angle speed δf′ has the same meaning as dδf/dt. As an example, the vehicle body orientation is calculated based on the extending direction of the target route and the vehicle length direction (sometimes referred to as a longitudinal direction) of the subject vehicle recognized from a camera image of the camera 1a or the like. As described above, the route lateral position deviation e [m] is a deviation amount in the lane width direction of the position of the subject vehicle from the target route. The route heading angle deviation Δψ [rad] is a deviation angle of the orientation (vehicle body orientation) of the subject vehicle with respect to the target route. The yaw angle speed deviation Δγ [rad/s] denotes a deviation between the yaw angle speed γ [rad/s] detected by the yaw rate sensor included in the internal sensor group 2 and the target yaw angle speed (=vehicle speed V [m/s]×route curvature κ [rad/m]). The route curvature κ [rad/m] is a curvature of the target route ahead in the advancing direction of the subject vehicle, and is calculated by the steering angle control unit 161, for example.

Next, the steering angle control unit 161 estimates a state quantity that cannot be observed using the internal sensor group 2, by using a state estimation model (Expressions (1) and (2) described later) described later in detail. In the embodiment, a steering angle disturbance δd and a vehicle body slip angle β [rad] are estimated, and an effective front-wheel steering angle δf\hat{ } [rad], which excludes the steering angle disturbance δd, is calculated.

“\hat{ }” indicates an estimated value. A relationship among the front-wheel steering angle δf, the effective front-wheel steering angle δf\hat{ }, and the steering angle disturbance δd is expressed by an expression of δf=δf\hat{ }+δd. Here, the steering angle disturbance δd refers to a steering angle that does not influence the behavior of the subject vehicle, for example, as a counter-steering against a cant angle φ [rad]. The cant angle φ is a gradient in the lane width direction (road surface cross gradient). The counter-steering caused by crosswinds or a center-point offset of the steering apparatus may be included in the steering angle disturbance δd.

The vehicle body slip angle β [rad] is a deviation angle between the orientation of the vehicle speed V and the vehicle body orientation of the subject vehicle.

Note that the above steering angle speed δf′ may be a sensor value by the steering angle speed sensor 2b or may be a value calculated based on a sensor value by the steering angle sensor 2a. In addition, a longitudinal component of the vehicle speed V is Vx [m/s], a lateral component thereof is Vy [m/s], and a lateral component of the gravitational acceleration g [m/s²] is gy [m/s²].

### <Optimal Steering Angle Sequence>

Next, the steering angle control unit 161 inputs the acquired vehicle state quantities, the above m, the above IZ, the above lf, the above lr, the above Kf, the above Kr, the above A, and the like to a travel simulation model (hereinafter, referred to as a prediction model). In the embodiment, an optimal steering angle (optimal steering angle sequence) for causing a future traveling position of the subject vehicle to follow a target route by model predictive control is calculated using a prediction model (Expressions (5) and (6) described in detail later). Details of the prediction model and the model predictive control will be described later.

### <Steering Angle Instruction Value>

The steering angle control unit 161 extracts a steering angle to be instructed at a preview time ahead from the optimal steering angle sequence, outputs, as a steering angle instruction value, a target steering angle added with the steering angle disturbance Sd excluded in advance, and controls the steering angle by the steering actuator AC1.

Note that, while the steering angle control based on the target steering angle is being executed, when the steering torque is detected by the steering torque sensor 2c, the steering angle control unit 161 may determine that the steering operation by the driver has been performed (an instruction to change the steering angle has been made) and interrupt the steering angle control.

In addition, while the steering angle control based on the target steering angle is being executed, the steering angle control unit 161 may continue the steering angle control based on the target steering angle, unless the steering torque sensor 2c detects large steering torque from which the driver's intention to release route-follow driving can be clearly understood, in other words, unless a steering operation of changing the steering angle by a predetermined value or more is performed.

### <Flow of Steering Angle Control>

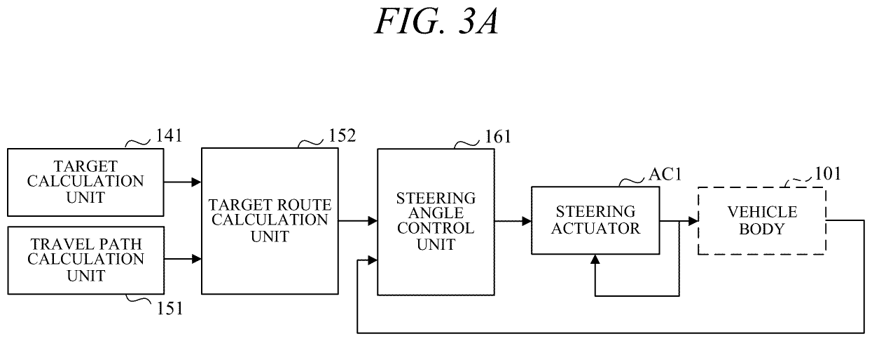

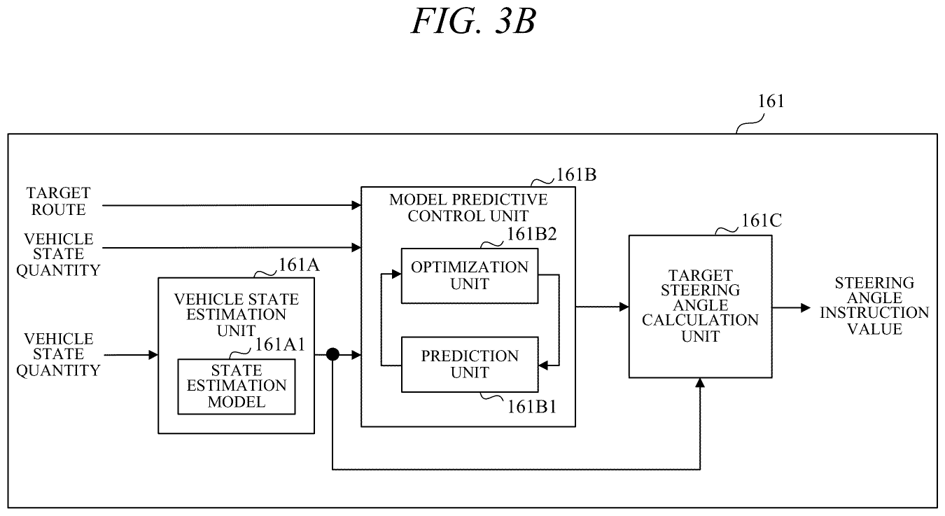

FIG. 3A is a block diagram for explaining a flow of steering angle control by the steering angle control unit 161. In the configuration illustrated in FIG. 2, the target calculation unit 141, the travel path calculation unit 151, the target route calculation unit 152, the steering angle control unit 161, the steering actuator AC1, and a vehicle body of a subject vehicle 101 are illustrated.

FIG. 3B is a block diagram illustrating details of the steering angle control unit 161 in FIG. 3A. The steering angle control unit 161 includes a vehicle state estimation unit 161A using a Kalman filter, a model predictive control unit 161B, and a target steering angle calculation unit 161C. In addition, the vehicle state estimation unit 161A using the Kalman filter includes a state estimation model 161A1. Furthermore, the model predictive control unit 161B includes a prediction unit 161B1 and an optimization unit 161B2.

### <Model Predictive Control>

The model predictive control will be described with reference to FIG. 3B. The model predictive control is a prior art. The model predictive control is one of control methods for calculating an optimal control input by using predictive estimation of a control target. In the model predictive control, a prediction model and an optimizer are used. The prediction model is a model for representing the control target. In the embodiment, the prediction unit 161B1 obtained by combining the vehicle model and the route deviation model is used as the prediction model. Furthermore, the optimization unit 161B2 that evaluates the operation of the prediction unit 161B1 and calculates an optimal control input is used as the optimizer.

FIG. 4A is a diagram illustrating the position of the subject vehicle 101, a target route Tr, and a predicted route Pr. FIG. 4B is a schematic diagram illustrating a relationship between a two-wheel model and the target route Tr according to the embodiment. Symbols in the drawing correspond to the vehicle speed V (a vehicle body longitudinal speed Vx, a vehicle body lateral speed Vy) of the subject vehicle 101, the center of gravity G, the yaw angle speed γ, the route heading angle deviation Δγ of the vehicle body, the route lateral position deviation e of the vehicle body, the distance lf between the center of gravity G and the front axle, the distance lr between the center of gravity G and the rear axle, the front-wheel steering angle δf, the target route Tr, the vehicle body slip angle β, a front-wheel slip angle βf, and a rear-wheel slip angle βr. In addition, Symbol 2Fyf represents a front-wheel cornering force [N] which is the product of the above Kf [N/rad] and the above βf [rad]. Symbol 2Fyr represents a rear-wheel cornering force [N] which is a product of the above Kr [N/rad] and the above βr [rad].

In the embodiment, the motion model of the subject vehicle 101 is represented by an equivalent two-wheel model in which two front wheels and two rear wheels provided in the subject vehicle 101 are moved to the center axis of the vehicle body.

The vehicle state estimation unit 161A in FIG. 3B estimates, by the state estimation model 161A1, the steering angle disturbance δd, the vehicle body slip angle β [rad], and the like based on the vehicle state quantity.

Following Expression (1) is a state equation of the state estimation model 161A1. Following Expression (2) is an output equation (also referred to as an observation equation) of the state estimation model 161A1. Expressions (1) and (2) are an example of a continuous-time state estimation model using a steering angle speed input vehicle model (two-wheel model) as the vehicle model.

$${x}^{′} = {A}_{s} x + {B}_{s} u \qquad ( 1 )$$

$$y = {C}_{s} x \qquad ( 2 )$$

Herein, a coefficient matrix in the expression is as follows.

$$As = [ \begin{matrix}- \frac{2 ( {K}_{f} + {K}_{r} )}{m V} & - 1 - 1 \frac{2 ( {l}_{f} {K}_{f} - {l}_{r} {K}_{r} )}{m {V}^{2}} & \frac{2 {K}_{f}}{m V} & 0 \\ - \frac{2 ( {l}_{f} {K}_{f} - {l}_{r} {K}_{r} )}{{I}_{z}} & - \frac{2 ( {l}_{f}^{2} {K}_{f} + {l}_{r}^{2} {K}_{r} )}{{I}_{z} V} & \frac{2 {l}_{f} {K}_{f}}{{I}_{z}} & 0 \\ 0 & 0 & 0 & 0 \\ 0 & 0 & 0 & 0\end{matrix} ] , \\ Bs = [ \begin{matrix}0 \\ 0 \\ 1 \\ 0\end{matrix} ] , \\ Cs = [ \begin{matrix}0 & 1 & 0 & 0 \\ 0 & 0 & 1 & 1\end{matrix} ]$$

In addition, x=[β, γ, δf\hat{ }, δd]T, u=δf′, and y=[γ, δf] T in the expression. Furthermore, symbols in the expression are the above Kf [N/rad], the above Kr [N/rad], the above m [kg], the above V [m/s], the above lf [m], the above lr [m], and the above IZ [kgm²]. Some of these correspond to the symbols in FIG. 4B.

Note that “[ ]T” indicates a transposed matrix. In addition, “′” indicates time differentiation. That is, x′ has the same meaning as dx/dt, and of has the same meaning as dδf/dt. Furthermore, “\hat{ }” indicates an estimated value. That is, δf\hat{ } is an effective front-wheel steering angle estimated value of δf.

When the state equation and the output equation of above Expressions (1) and (2) are discretized, if zero-order hold assumption is applied to estimate the steering angle disturbance δd or the like, a zero-order hold discrete-time state estimation model is obtained. The zero-order hold assumption refers to, for example, a concept that the state at a previous sample time is maintained until a next sample time.

The state estimation model 161A1 models a vehicle state quantity influenced by factors such as the front-wheel steering angle speed δf′ [rad/s], for example, and computes estimated values of the steering angle disturbance δd and the vehicle body slip angle β using these factors, observed vehicle state quantities, and previous estimated values. In addition, in general, the vehicle state quantities actually observed constantly include a noise component (observation noise), and further include a noise component (process noise) indicating model uncertainty.

By repeating the estimation computation using the state estimation model 161A1, estimation with the smallest error is performed in consideration of an observation value and the model uncertainty.

The model predictive control unit 161B inputs the target route Tr and the observed or estimated vehicle state quantity of the subject vehicle 101 and performs model predictive computation, thereby performing processing (solution search computation) of obtaining an optimal steering angle sequence for several future seconds (prediction horizon) while predicting the speed and the traveling direction (predicted route Pr) of the subject vehicle 101 for several future seconds (prediction horizon) on the model at predetermined computation intervals (for example, several milliseconds to several seconds). In the embodiment, the input x to the prediction model is information indicating the state of the subject vehicle 101 (β, γ, Δψ, e), the input u is information indicating the input of the subject vehicle 101 (front-wheel steering angle δf), and the input w is information indicating the curvature κ of the target route Tr. As the steering angle δf of the input u, the above estimated value δf\hat{ } obtained by excluding the steering angle disturbance δd estimated by the vehicle state estimation unit 161A from the actual steering angle δf acquired by the internal sensor group 2 is input.

### <Description of Prediction Model>

Following Expression (3) is a state equation of the prediction model of the prediction unit 161B1. Following Expression (4) is an output equation of the prediction model of the prediction unit 161B1. Expressions (3) and (4) are an example of a continuous-time prediction model based on a steering angle input vehicle model (referred to as a two-wheel model) as the vehicle model and a route deviation system.

$${x}^{′} = {A}_{C} x + {B}_{C} u + {W}_{C} w \qquad ( 3 )$$

$$y = {C}_{C} x \qquad ( 4 )$$

Herein, a coefficient matrix in the expression is as follows.

$$Ac = [ \begin{matrix}- \frac{2 ( {K}_{f} + {K}_{r} )}{m V} & - 1 - \frac{2 ( {l}_{f} {K}_{f} - {l}_{r} {K}_{r} )}{m {V}^{2}} & 0 & 0 \\ - \frac{2 ( {l}_{f} {K}_{f} - {l}_{r} {K}_{r} )}{{I}_{z}} & - \frac{2 ( {l}_{f}^{2} {K}_{f} + {l}_{r}^{2} {K}_{r} )}{{I}_{z} V} & 0 & 0 \\ 0 & 1 & 0 & 0 \\ V & 0 & V & 0\end{matrix} ] , \\ Bc = [ \begin{matrix}\frac{2 {K}_{f}}{m V} \\ \frac{2 {l}_{f} {K}_{f}}{{I}_{z}} \\ 0 \\ 0\end{matrix} ] , \\ Wc = [ \begin{matrix}0 \\ 0 \\ - V \\ 0\end{matrix} ] , \\ Cs = [ \begin{matrix}1 & 0 & 1 & 0 \\ 0 & 0 & 0 & 1\end{matrix} ]$$

In addition, x=[β, γ, Δψ, e]T, u=δf, w=κ, and y=[Δθ, e] T in the expression. Furthermore, symbols in the expression are the above Kf [N/rad], the above Kr [N/rad], the above m [kg], the above V [m/s], the above lf [m], the above lr [m], the above IZ [kgm²], the above β [rad], the above γ [rad/s], the above Δψ [rad], and the above e [m], and a route heading angle deviation Δθ [rad] of a speed vector.

In the embodiment, the route lateral position deviation e and the route heading angle deviation Δθ are treated as the route deviation system.

Note that “[ ] T” indicates a transposed matrix. In addition, “′” indicates time differentiation. That is, x′ has the same meaning as dx/dt, ψ′ has the same meaning as dψ/dt, and e′ has the same meaning as de/dt.

When the state equation and the output equation of above Expressions (3) and (4) are discretized, following Expressions (5) and (6) are obtained by applying first-order hold assumption. Expressions (5) and (6) are first-order hold discrete-time prediction models. The first-order hold makes it possible to maintain the accuracy of the curvature κ of the target route even when a long sample time is used, for example, as compared with the case of the zero-order hold. The first-order hold assumption refers to a concept that a state changes linearly from the state at the previous sample time to the state at the next sample time.

$$x ( k + 1 ) = {A}_{d} x ( k ) + {B}_{d 0} u ( k ) + {W}_{d 0} w ( k ) + {B}_{d 1} u ( k + 1 ) + {W}_{d 1} w ( k + 1 ) \qquad ( 5 )$$

$$y ( k ) = {C}_{d} x ( k ) \qquad ( 6 )$$

where x(k) is a state variable (in the embodiment, β, γ, Δψ, e), u(k) is a vehicle input (in the embodiment, the front-wheel steering angle δf), w(k) is a disturbance component (in the embodiment, the route curvature κ), and y(k) is a vehicle output (Δθ, e).

Note that Cd=C_{C}, Bd0=Bd−Bd1, and Wd0=Wd−Wd1. The sizes are Ad: nx×nx, Bd0: nx×nU, Wd0: nx×nW, Bd1: nx×nU, Wd1: nx×nW, and Cd: ny×nx.

According to above Expressions (5) and (6), by repeating obtaining the vehicle state quantity at a next step k+1 based on the vehicle state quantity at step k on the model, it is possible to predict the vehicle state quantity at Hp steps ahead (k=Hp) from the current time (k=0). More specifically, the prediction unit 161B1 inputs the observed or calculated current vehicle state quantity and the like of the subject vehicle 101 to the state equation, and predicts the vehicle state quantity corresponding to each of step k=1 to step k=Hp.

The optimization unit 161B2 represents, as a function, each of a plurality of elements (in the embodiment, the route lateral position deviation e, the route heading angle deviation Δθ, and the front-wheel steering angle difference Δδf) used for evaluation and outputs the sum of the function outputs as an evaluation function J. In addition, a constraint condition to be satisfied is also set.

Following Expression (7) is an example of the evaluation function J of the optimization unit 161B2. Following Expression (8) is an example of the constraint condition.

$$min J = {\sum }_{k = 1}^{{H}_{p}} {W}_{e} {e ( k )}^{2} + {W}_{Δ θ} Δ θ {( k )}^{2} + {W}_{Δ {δ}_{f}} {\{ {δ}_{f} ( k ) - {δ}_{f} ( k - 1 ) \}}^{2} \qquad ( 7 )$$

$${\dot{δ}}_{fmin} \leq \frac{{δ}_{f} ( k ) - {δ}_{f} ( k - 1 )}{{t}_{s}} \leq {\dot{δ}}_{fmax} \qquad ( 8 )$$

where Symbol ts is a prediction sampling time, Symbol Hp is a prediction horizon, Symbol We is a weighting factor for the square of the route lateral position deviation e, Symbol WΔθ is a weighting factor for the square of the route heading angle deviation Δθ of the speed vector, and Symbol WΔδf is a weighting factor for the square of the front-wheel steering angle difference Δδf. Hereinafter, the weighting factor is referred to as a weighting value. In addition, “dot” indicates time differentiation. That is, “dot” δf has the same meaning as dδf/dt.

In the embodiment, the evaluation function J is determined by a plurality of elements. Specifically, the evaluation function J is a function f1 for the route lateral position deviation e of the vehicle body, a function f2 for the route heading angle deviation Δδ of the speed vector, and a function f3 for the front-wheel steering angle difference Δδf. The evaluation function J is a function including these three elements. The optimization unit 161B2 obtains the smallest numerical value of the evaluation function J determined by the sum of the three functions f1, f2, and f3.

The three functions f1, f2, and f3 will be described in more detail. The optimization unit 161B2 calculates a multiplication result of the square of the route lateral position deviation e(k) and a weighting value We at each step from the next step k=1 to the Hp steps ahead (k=Hp) in the future, and sets the multiplication result as the function f1 for the route lateral position deviation e.

In addition, the optimization unit 161B2 calculates a multiplication result of the square of the route heading angle deviation Δθ(k) and a weighting value WΔθ at each step from the next step k=1 to the Hp steps ahead (k=Hp) in the future, and sets the multiplication result as the function f2 for the route heading angle deviation Δθ.

Furthermore, the optimization unit 161B2 calculates a multiplication result of the square of the steering angle difference (Δδf(k)−Δδf(k−1)) and a weighting value WΔδf at each step from the next step k=1 to the Hp steps ahead (k=Hp) in the future, and sets the multiplication result as the function f3 for the steering angle difference Δδf.

The model predictive control unit 161B having the above-described configuration repeats loop processing by the prediction unit 161B1 and the optimization unit 161B2 a plurality of times for each computation cycle, and determines the optimal steering angle sequence that satisfies the constraint condition and minimizes the evaluation function J. In other words, the optimal steering angle sequences u(1) to u(Hp) at each step from the next step k=1 to the Hp steps ahead (k=Hp) in the future are determined as steering angle instruction value candidates.

### <Change of Weighting Value>

In the embodiment, by changing the weighting value, it is possible to set an element prioritized over other elements among a plurality of elements (in the embodiment, the route lateral position deviation e, the route heading angle deviation Δθ, and the front-wheel steering angle difference Δδf) used for evaluation.

For example, by setting the weighting value We to be larger than the other weighting values WΔθ and WΔδf, it becomes possible to perform steering angle control to converge the route lateral position deviation e as fast as possible within a range in which the subject vehicle 101 can respond (the range of the constraint condition according to above Expression (8)).

Similarly, by setting the weighting value WΔθ to be larger than the other weighting values We and WΔδf, it becomes possible to perform steering angle control to converge the route heading angle deviation Δθ as fast as possible within a range in which the subject vehicle 101 can respond (the range of the constraint condition according to above Expression (8)).

In contrast to the above two examples, by setting the weighting value WΔδf to be larger than the other weighting values We and WΔθ, it becomes possible to perform steering angle control to suppress the steering angle difference Δδf to be small (in other words, to avoid steering as much as possible). Due to the difficulty in steering, the subject vehicle 101 does not turn, resulting in steering angle control that does not follow the target route. Note that a weighting value for emergency avoidance for performing control to steer as much as possible, which is opposite to control to make it difficult to steer, can also be set. Specifically, by setting the weighting value WΔδf to zero, the subject vehicle 101 can perform steering angle control that prioritizes danger avoidance at all costs over the influence on the occupant (ride comfort or the like).

The target steering angle calculation unit 161C inputs the steering angle disturbance od estimated by the vehicle state estimation unit 161A and the optimal steering angle sequences u(1) to u(Hp) determined by the model predictive control unit 161B, extracts a steering angle to be instructed at a predetermined preview time tp ahead from the optimal steering angle sequence, and outputs, as a steering angle instruction value after next several milliseconds, a target steering angle added with the steering angle disturbance δd excluded in advance to the steering actuator AC1. In the embodiment, the steering angle corresponding to the preview time tp is obtained by linear interpolation from the optimal steering angle sequences u(1) to u(Hp).

### <Vehicle Model in Prediction Model>

In general, the same type of vehicle model is used as the vehicle model used for the state equation of the state estimation model 161A1 and the vehicle model used for the state equation of the prediction model of the prediction unit 161B1. In addition, a method of discretization is also common. For example, in a case where the vehicle model of the steering angle speed input type and the zero-order hold discretization are used for the state estimation model 161A1, the vehicle model of the steering angle speed input type and the zero-order hold discretization are also used for the prediction model. This is because the use of the same type of vehicle model and discretization method provides excellent consistency in terms of vehicle behavior between the state estimation and the model prediction. However, in this prediction model, the input of the curvature κ of the target route becomes the zero-order hold discretization, and the deviation from the continuous-time target route may become large in a long sample time. That is, the prediction accuracy of the behavior of the subject vehicle 101 including the deviations in the position and direction of the subject vehicle 101 with respect to the target route may deteriorate. In addition, there is also a problem that the number of state variables of the prediction model is large, and the computation load and the memory usage in the prediction unit 161B1 increase.

Therefore, in the embodiment, the first-order hold discretization is used for the prediction model in order that the input of the curvature κ of the target route in the prediction model can keep the deviation from the continuous-time target route small even in a long sample time, that is, in order to improve the prediction accuracy of the behavior of the subject vehicle 101 including the deviations in the position and direction of the subject vehicle 101 with respect to the target route. In addition, the vehicle model included in the prediction model inputs the front-wheel steering angle of so that an equivalent vehicle behavior can be predicted even for a change in the discretization method. The vehicle model having, as an input, the front-wheel steering angle of can reduce the number of state variables (reduce the dimension) as compared with the vehicle model having, as an input, the front-wheel steering angle speed of, so that it is also possible to expect an effect of reducing the computation load and the memory usage.

Based on the above idea, different types of vehicle models and discretization methods were used for the state estimation and the model prediction as follows. Specifically, the difference is that the state estimation model represented by above Expressions (1) and (2) uses the zero-order hold discretization, whereas the prediction model represented by above Expressions (3) and (4) adopted in the embodiment uses the first-order hold discretization. In addition, the difference is that the vehicle model of the state equation of above Expression (1) corresponds to three rows enclosed by broken lines among coefficient matrices As and Bs, and the front-wheel steering angle speed of is input as the input u, whereas the vehicle model of the state equation of above Expression (3) adopted in the embodiment corresponds to two rows enclosed by broken lines among coefficient matrices Ac, Bc, and Wc, and the front-wheel steering angle of is input as the input u.

Following Expression (9) is a state equation of the prediction model before improvement to above Expression (3) adopted in the embodiment. Following Expression (10) is an output equation of the prediction model before improvement to above Expression (4) adopted in the embodiment. Expressions (9) and (10) before improvement are an example of a continuous-time prediction model based on the steering angle speed input vehicle model (two-wheel model) as the vehicle model and the route deviation system.

$${x}^{′} = {oldA}_{C} x + {oldB}_{C} u + {oldW}_{C} w \qquad ( 9 )$$

$$y = {oldC}_{C} x \qquad ( 10 )$$

Herein, a coefficient matrix in the expression is as follows.

$$oldAc = [ \begin{matrix}- \frac{2 ( {K}_{f} + {K}_{r} )}{m V} & - 1 - \frac{2 ( {l}_{f} {K}_{f} - {l}_{r} {K}_{r} )}{m {V}^{2}} & \frac{2 {K}_{f}}{m V} & 0 & 0 \\ - \frac{2 ( {l}_{f} {K}_{f} - {l}_{r} {K}_{r} )}{{I}_{z}} & - \frac{2 ( {l}_{f}^{2} {K}_{f} + {l}_{r}^{2} {K}_{r} )}{{I}_{z} V} & \frac{2 {l}_{f} {K}_{f}}{{I}_{z}} & 0 & 0 \\ 0 & 0 & 0 & 0 & 0 \\ 0 & 1 & 0 & 0 & 0 \\ V & 0 & 0 & V & 0\end{matrix} ] , \\ oldBc = [ \begin{matrix}0 \\ 0 \\ 1 \\ 0 \\ 0\end{matrix} ] , \\ oldWc = [ \begin{matrix}0 \\ 0 \\ 0 \\ - V \\ 0\end{matrix} ] , \\ oldCs = [ \begin{matrix}1 & 0 & 0 & 1 & 0 \\ 0 & 0 & 0 & 0 & 1 \\ 0 & 0 & 1 & 0 & 0\end{matrix} ]$$

In addition, x=[β, γ, δf, Δψ, e]T, u=δf′, w=κ, and y=[Δθ, e, δf]T in the expression. Furthermore, symbols in the expression are the above Kf [N/rad], the above Kr [N/rad], the above m [kg], the above V [m/s], the above lf [m], the above lr [m], the above IZ [kgm²], the above β [rad], the above γ [rad/s], the above Δψ [rad], the above e [m], and the above Δθ [rad].

Note that “[ ] T” indicates a transposed matrix. In addition, “′” indicates time differentiation. That is, x′ has the same meaning as dx/dt, ψ′ has the same meaning as dψ/dt, and of has the same meaning as of/dt.

When the state equations and the output equations of above Expressions (9) and (10) are discretized, Expressions (11) and (12) are obtained by applying the zero-order hold assumption. Expressions (11) and (12) are zero-order hold discrete-time prediction models. As described above, the zero-order hold assumption refers to, for example, a concept that the state at a previous sample time is maintained until a next sample time.

$$x ( k + 1 ) = {A}_{d} x ( k ) + {B}_{d} u ( k ) + {W}_{d} w ( k ) \qquad ( 11 )$$

$$y ( k ) = {C}_{d} x ( k ) \qquad ( 12 )$$

where x(k) is a state variable (β, γ, δf, Δψ, e), u(k) is a vehicle input (front-wheel steering angle speed δf′), w(k) is a disturbance component (route curvature κ), and y(k) is a vehicle output (Δθ, e, δf). That is, the number of vehicle state quantities treated as x(k) is larger before improvement. In addition, the input of u(k) is the front-wheel steering angle of in the embodiment, whereas the input is the front-wheel steering angle speed of before improvement.

According to above Expression (9) of the prediction model before improvement and above Expression (1) of the state estimation model of the embodiment, the type of the vehicle model is the same between the model prediction and the state estimation. In addition, when both models are discretized, the zero-order hold assumption is applied. Specifically, the similarity is that the vehicle model of the state equation of above Expression (9) corresponds to three rows enclosed by broken lines among coefficient matrices oldAc, oldBc, and oldWc, and the front-wheel steering angle speed δf′ is input as the input u, whereas the vehicle model of the state equation of above Expression (1) corresponds to three rows enclosed by broken lines among the coefficient matrices As and Bs, and the front-wheel steering angle speed of is input as the input u. Therefore, consistency between the model prediction and the state estimation is excellent.

However, the prediction model represented by above Expressions (3) and (4) adopted in the embodiment uses the first-order hold discretization, and the input of the curvature κ of the target route can keep the deviation from the continuous-time target route small even in a long sample time, that is, the prediction accuracy of the behavior of the subject vehicle 101 including the deviations in the position and direction of the subject vehicle 101 with respect to the target route can be improved as compared with the prediction model using the zero-order hold discretization of the prediction model represented by above Expressions (9) and (10) before improvement. Improvement in prediction accuracy is extremely important for improvement in the performance of follow driving along the target path.

In addition, the vehicle model included in the prediction model using the first-order hold discretization represented by above Expressions (3) and (4) inputs the front-wheel steering angle δf, and it is possible to predict the vehicle behavior equivalent to the vehicle model using, as an input, the front-wheel steering angle speed of included in the prediction model using the zero-order hold discretization represented by above Expressions (9) and (10) before improvement.

Furthermore, the vehicle model included in the prediction model using the first-order hold discretization represented by above Expressions (3) and (4) inputs the front-wheel steering angle δf, and it is possible to reduce the number of state variables (reduce the dimension) as compared with the vehicle model using the front-wheel steering angle speed δf′ included in the prediction model using the zero-order hold discretization represented by above Expressions (9) and (10) before improvement, and thus, it is possible to reduce the computation load and the memory usage. That is, implementation on a lower-specification ECU and the like becomes possible.

### <Description of Flowchart>

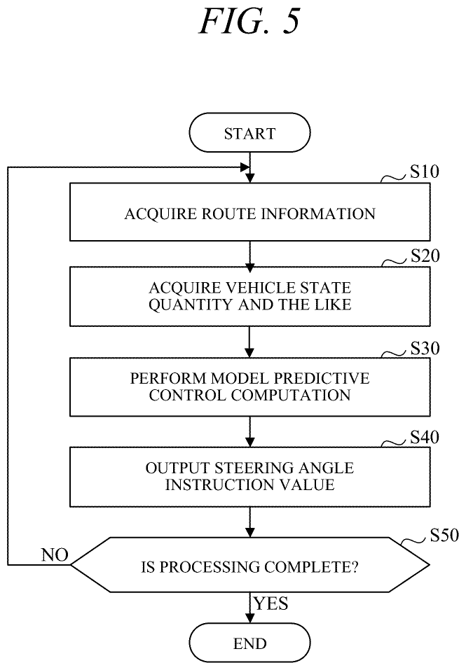

FIG. 5 is a flowchart illustrating an example of computation processing executed by the processing unit 11 of the controller 10 in FIG. 2 according to a predetermined program. The processing illustrated in the flowchart is repeatedly executed, for example, while the subject vehicle 101 is traveling in the self-drive mode. In addition, the processing is repeatedly executed when the subject vehicle 101 is traveling in the manual drive mode and, for example, the lane keeping capability, which is one of the driving assistance capabilities, is enabled, that is, when the subject vehicle 101 is traveling in the lane keep driving.

In step S10, the controller 10 causes the steering angle control unit 161 to acquire the route information as the above-described target route, and proceeds to step S20.

In step S20, the controller 10 causes the steering angle control unit 161 to acquire the above-described vehicle state quantity and the like, and proceeds to step S30.

In step S30, the controller 10 causes the steering angle control unit 161 to perform the above-described model predictive control computation, and proceeds to step S40.

In step S40, the controller 10 causes the steering angle control unit 161 to perform the above-described target steering angle calculation, output a steering angle instruction value, and execute the steering angle control, and proceeds to step S50. Accordingly, the steering actuator AC1 is controlled based on the steering angle instruction value.

In step S50, the controller 10 determines whether or not to end the processing. For example, when the self-drive mode is released, the controller 10 makes an affirmative determination in step S50 and ends the processing according to FIG. 5. For example, when the self-drive mode is continued, the controller 10 makes a negative determination in step S50, returns to step S10, and repeats the above-described processing.

According to the embodiments described above, the following effects are obtained.

(1) A steering angle control apparatus 50 that controls a steering angle δf of a subject vehicle 101 so as to travel following a target route Tr includes: a vehicle state estimation unit 161A as an estimation unit that estimates a steering angle disturbance δd, a slip angle β, and the like as second vehicle state quantities not acquired by an internal sensor group 2 of the subject vehicle 101, based on a vehicle speed V, a front-wheel steering angle speed δf′, a yaw angle speed γ, and the like as first vehicle state quantities acquired by the internal sensor group 2 as a sensor of the subject vehicle 101, among vehicle state quantities indicating a motion state of the subject vehicle 101; a prediction unit 161B1 that predicts, up to a predetermined time ahead, the vehicle speed V, the yaw angle speed γ, and the like as a behavior of the subject vehicle 101 including a route lateral position deviation e and a route heading angle deviation Δθ as deviations in a position and a direction of the subject vehicle 101 with respect to the target route Tr, based on the first vehicle state quantities, the second vehicle state quantities, and information indicating the target route Tr; and an optimization unit 161B2 that optimizes a target steering angle by using a prediction result obtained by the prediction unit 161B1, in which the vehicle state estimation unit 161A includes a state estimation model (state equation (1), output equation (2)) including a first vehicle model that models a relationship between the first vehicle state quantities and the second vehicle state quantities, and vehicle characteristic information (Kf, Kr, m, lf, lr, IZ) regarding a motion characteristic of the subject vehicle 101, the prediction unit 161B1 includes a prediction model (state equation (3), output equation (4)) including a second vehicle model that models the relationship between the first vehicle state quantities and the second vehicle state quantities, and the vehicle characteristic information (Kf, Kr, m, lf, lr, IZ), the state estimation model and the prediction model have different discretization methods, and information regarding the steering angle (steering angle speed of, steering angle δf) as the first vehicle state quantities is input in different formats to the first vehicle model and the second vehicle model.

With this configuration, by using different discretization methods for the state estimation model and the prediction model, the zero-order hold assumption can be applied to the state estimation model, and the first-order hold assumption can be applied to the prediction model. In addition, by inputting steering angle information to the first vehicle model for state estimation and the second vehicle model for model prediction in different formats, it is possible to input the steering angle speed δf′ to the first vehicle model for state estimation and input the steering angle δf to the second vehicle model for model prediction. That is, the discretization method and the format of the steering angle information can be selectively used according to the purpose. Note that the purpose of the state estimation is to estimate a state that cannot be observed by the internal sensor group 2, and the purpose of the model prediction is to accurately predict the future behavior of the subject vehicle 101 and to realize the prediction with a low computation load. Improvement in prediction accuracy leads to improvement in the performance of follow driving along the target path. By selectively using the discretization method and the format of the steering angle information, it is possible to achieve both the purposes of the state estimation and the model prediction.

Further, by selectively using the format of the steering angle information, the size of the vehicle model for model prediction (two rows enclosed by broken lines among coefficient matrices Ac, Bc, and Wc) of the embodiment can be made smaller than the size of the vehicle model for model prediction before improvement (three rows enclosed by broken lines among coefficient matrices oldAc, oldBc, and oldWc). In other words, in the embodiment, by adopting the vehicle model (above Expression (3)) that takes the front-wheel steering angle δf as the input u instead of the vehicle model before the improvement (above Expression (9)) that takes the front-wheel steering angle speed δf′ as the input u, the size of the vehicle model is made smaller than that before improvement. In this manner, by reducing the number of the vehicle state quantities handled in the model predictive computation and reducing the computation load by the prediction unit 161B1, implementation on a lower-specification ECU and the like becomes possible.

(2) In the steering angle control apparatus 50 of above (1), the information regarding the steering angle is input as the steering angle speed δf′ to the first vehicle model of the state estimation model.

With this configuration, it is possible to satisfy the necessity of using a vehicle model having the steering angle δf as a state variable in the first vehicle model of the state estimation model. Accordingly, it is possible to accurately estimate the vehicle state quantity.

(3) In the steering angle control apparatus 50 of above (1), zero-order hold assumption is applied to the state estimation model during discretization.

With this configuration, the value of the steering angle speed δf′ of the state estimation model is maintained until a next sample time, and consistency with actual driving is improved. Accordingly, it is possible to accurately estimate the vehicle state quantity.

(4) In the steering angle control apparatus 50 of above (1) or (2), the information regarding the steering angle is input as the steering angle of to the second vehicle model of the prediction model.

With this configuration, it is possible to use the vehicle model that takes, as an input, steering angle δf, based on an idea that the vehicle model that takes, as an input, the steering angle speed of does not necessarily need to be used as the second vehicle model of the prediction model. In the vehicle model that takes, as an input, the steering angle δf, the vehicle state quantity used for computation is reduced as compared with the vehicle model that takes, as an input, the steering angle speed δf′, and thus, it is possible to reduce the number of the vehicle state quantities handled in the model predictive computation and reduce the computation load by the prediction unit 161B1.

(5) In the steering angle control apparatus 50 of above (4), the prediction model (state equation (3), output equation (4)) includes, together with the second vehicle model, a route deviation model that models a relationship among the first vehicle state quantities (vehicle speed V, front-wheel steering angle δf, yaw angle speed γ, route heading angle deviation Δψ, and the like) and the second vehicle state quantity (slip angle β), a deviation (route lateral position deviation e, route heading angle deviation Δθ), and a curvature κ of the target route Tr.

With this configuration, the model predictive control unit 161B can obtain the steering angle instruction value for appropriately eliminating the route lateral position deviation e and the route heading angle deviation Δθ as the deviations in the position and the direction of the subject vehicle 101 with respect to the target route Tr.

(6) In the steering angle control apparatus 50 of above (1), first-order hold assumption is applied to the prediction model (state equation (3), output equation (4)) during discretization.

If the zero-order hold assumption is applied during discretization, a difference between an input (the curvature κ of the target route) by a continuous-time state equation and an input (the curvature κ of the target route) by a discrete-time state equation may become large, so that it becomes difficult to use a long sample time. On the other hand, if the first-order hold assumption is applied, the difference between the input (the curvature κ of the target route) by the continuous-time state equation and the input (the curvature κ of the target route) by the discrete-time state equation is suppressed as compared with the case of zero-order hold. Accordingly, it is possible to improve the prediction accuracy of the deviation in the position and the direction of the subject vehicle 101 with respect to the target route. Note that since the zero-order hold discretization of the steering angle speed of input vehicle model and the first-order hold discretization of the steering angle of input vehicle model are equivalent, the prediction accuracy of the vehicle behavior is equivalent. In other words, it is possible to accurately predict the behavior of the subject vehicle 101 over a longer distance, and the performance of follow driving along the target path is improved.

The above embodiments may be modified into various modes. Hereinafter, modifications will be described.

### (First Modification)

In the above embodiments, the vehicle speed (vehicle body speed) V [m/s] of the subject vehicle, the yaw angle speed (yaw rate) γ [rad/s], the front-wheel steering angle of [rad], the acceleration g [m/s²], the steering angle speed of [rad/s], the vehicle body orientation, the route lateral position deviation e [m], the route heading angle deviation Δψ [rad] of the vehicle body, the yaw angle speed deviation Δγ [rad/s], the vehicle body slip angle β [rad], and the like are exemplified as the vehicle state quantities, but, a state quantity other than the above may be added.

### (Second Modification)

In the above embodiments, the values of the weighting values We, WΔθ, and WΔδf for the first element and the second element may be changed as appropriate. In addition, the values of the weighting values We, WΔθ, and WΔδf for emergency avoidance may also be changed as appropriate. That is, the values of the weighting values We, WΔθ, and WΔδf applied to the evaluation function (Expression (7)) may be changed as appropriate.

The above embodiment can be combined as desired with one or more of the aforesaid modifications. The modifications can also be combined with one another.

According to the present invention, it is possible to improve the prediction accuracy of the behavior of the vehicle including the deviation in the position and the direction of the vehicle with respect to the target route as compared with the related art. As a result, the performance of follow driving along the target path is improved.

Above, while the present invention has been described with reference to the preferred embodiments thereof, it will be understood, by those skilled in the art, that various changes and modifications may be made thereto without departing from the scope of the appended claims.

What is claimed is:

1. A steering angle control apparatus configured to control a steering angle of a vehicle such that the vehicle travels following a target route, the steering angle control apparatus comprising:
a microprocessor; and
a memory connected to the microprocessor, wherein
the microprocessor is configured to perform:
estimating a second vehicle state quantity not acquired by a sensor of the vehicle, based on a first vehicle state quantity acquired by the sensor, among vehicle state quantities indicating a motion state of the vehicle;
predicting, up to a predetermined time ahead, a behavior of the vehicle including deviations in a position and a direction of the vehicle with respect to the target route, based on the first vehicle state quantity, the second vehicle state quantity, and information indicating the target route; and
optimizing a target steering angle by using a result of the predicting, wherein
the microprocessor is configured to perform:
the estimating including estimating using a first vehicle model modeling a relationship between the first vehicle state quantity and the second vehicle state quantity, and vehicle characteristic information regarding a motion characteristic of the vehicle;
the predicting including predicting, up to the predetermined time ahead, the behavior using a prediction model including a second vehicle model modeling a relationship between the first vehicle state quantity and the second vehicle state quantity, and the vehicle characteristic information;
the state estimation model and the prediction model have different methods of discretization; and
information regarding the steering angle as the first vehicle state quantity is input in different formats to the first vehicle model and the second vehicle model.

2. The steering angle control apparatus according to claim 1, wherein
the information regarding the steering angle is input as a steering angle information speed to the first vehicle model.

3. The steering angle control apparatus according to claim 1, wherein
zero-order hold assumption is applied to the state estimation model during the discretization.

4. The steering angle control apparatus according to claim 1, wherein
the information regarding the steering angle is input as a steering angle information to the second vehicle model.

5. The steering angle control apparatus according to claim 4, wherein
the prediction model includes, together with the second vehicle model, a route deviation model modeling a relationship among the first vehicle state quantity and the second vehicle state quantity, the deviation, and a curvature of the target route.

6. The steering angle control apparatus according to claim 1, wherein
first-order hold assumption is applied to the prediction model during the discretization.

7. A steering angle control method for controlling a steering angle of a vehicle such that the vehicle travels following a target route, the steering angle control method comprising:
estimating a second vehicle state quantity not acquired by a sensor of the vehicle, based on a first vehicle state quantity acquired by the sensor, among vehicle state quantities indicating a motion state of the vehicle;
predicting, up to a predetermined time ahead, a behavior of the vehicle including deviations in a position and a direction of the vehicle with respect to the target route, based on the first vehicle state quantity, the second vehicle state quantity, and information indicating the target route; and
optimizing a target steering angle by using a result of the predicting, wherein
the estimating includes estimating using a first vehicle model modeling a relationship between the first vehicle state quantity and the second vehicle state quantity, and vehicle characteristic information regarding a motion characteristic of the vehicle,
the predicting includes predicting, up to the predetermined time ahead, the behavior using a prediction model including a second vehicle model modeling a relationship between the first vehicle state quantity and the second vehicle state quantity, and the vehicle characteristic information,
the state estimation model and the prediction model have different methods of discretization, and
information regarding the steering angle as the first vehicle state quantity is input in different formats to the first vehicle model and the second vehicle model.
